(19) United States
(12) Patent Application Publication
(10) Pub. No.: US 2002/0063355 A1
(43) Pub. Date: May 30, 2002

(54) Device and method for controlling temperature of injection molding machine using temperature controller

(76) Inventor: Young-Hee Yu, Seoul (KR)

Correspondence Address: MCDERMOTT WILL & EMERY, 600 13TH STREET, N.W., WASHINGTON, DC, 20005-3096, US

(21) Appl. No.: 09/922,930

(22) Filed: Aug. 7, 2001

(30) Foreign Application Priority Data
Nov. 27, 2000 (KR) 2000-0070948

(51) Int. Cl. B29C 45/77

(52) U.S. Cl. 264/40.6; 425/143

(57) ABSTRACT

Disclosed is a device and a method for controlling a temperature of an injection molding machine using a temperature controller, in which a temperature of feed water fed from a cooling tower to the injection molding machine is controlled by heat supplied from a heater, and then a temperature of the injection molding machine is controlled by opening or closing a plurality of opening and closing means to regulate feeding of the water from the cooling tower to the injection molding machine. By the present invention, a time required for controlling the temperature of the injection molding machine and a preheating time at an initial operation stage can be shortened.

### BACKGROUND OF THE INVENTION

1. Field of the Invention

The present invention relates to a device and a method for controlling a temperature of an injection molding machine, and more particularly to a device and a method for controlling a temperature of an injection molding machine using a temperature controller, in which a time required for controlling the temperature of the injection molding machine and a preheating time at an initial stage of an operation can be shortened.

2. Description of the Prior Art

In order to increase quality of products and reduce production of defective products in accordance with change in a temperature of cooling water, and to reduce power consumption due to unnecessary operation of a cooling tower, Korean Utility Model Application No. 1999-25871 filed on Dec. 12, 1999 discloses a device for controlling a temperature of cooling water of an injection molding machine including a mold, which has a cooling water bucket and a cooling tower as in the prior art, but further has a series of structures that a temperature sensing bar is provided in the cooling water bucket while being connected to a thermostat, and that the thermostat is in turn connected to the cooling tower to be switched between “on” and “off” states.

In case of controlling the temperature of the cooling water of the injection molding machine by such a temperature control device of above structures, however, the temperature is controlled not entirely but partially at one time, which results in problems of deteriorating the quality of the products and producing the defective products. There is also a disadvantage in that it takes a very long time to heat the injection molding machine at the initial stage of the operation only by heat for the injection molding.

### SUMMARY OF THE INVENTION

Accordingly, the present invention has been made to overcome the above-mentioned problems, and it is an object of the present invention to provide a device and a method for controlling a temperature of an injection molding machine using a temperature controller, in which a time required for controlling a temperature of the injection molding machine and a preheating time at an initial stage of an operation can be shortened.

To accomplish this object, there is provided a device for controlling a temperature of an injection molding machine using a temperature controller in accordance with one aspect of the present invention, the device comprising:

a first and a second pump for forcedly supplying feed water from a cooling tower to a pipe within the injection molding machine and a heater by their pumping actions, respectively, the heater heating the feed water supplied from the cooling tower by the pumping action of the first pump and supplying the heated water to the pipe within the injection molding machine;

a first opening and closing means provided between the pipe within the injection molding machine and the heater for regulating feeding of the water from the heater to the pipe within the injection molding;

a second opening and closing means provided between the pipe within the injection molding machine and the first pump for regulating returning of the water from the pipe within the injection molding machine to the first pump;

a third opening and closing means provided between the pipe within the injection molding machine and the second pump for regulating feeding of the water from the second pump to the pipe within the injection molding machine;

a fourth opening and closing means provided between the pipe within the injection molding machine and the cooling tower for regulating discharging of the water from the pipe within the injection molding machine to the cooling tower;

temperature sensors for detecting temperatures of the feed water from the cooling tower, the hot water within the heater and the cooling water within the injection molding machine; and

control means for controlling operations of the injection molding machine and controlling actions of the pumps, the heater and the first to fourth opening and closing means depending on temperature values of the temperature sensors and setting values of a timer.

It is preferred that each of the first to the fourth opening and closing means is a solenoid valve, and a check valve is provided at a rear end of the solenoid valve.

The second and the fourth opening and closing means may further include a manifold, respectively.

The control means preferably controls the temperatures of the injection molding machine by selectively opening or closing a plurality of the opening and closing means to regulate the inflow or discharge of the cooling water into or from the injection molding machine.

In accordance with another aspect of the present invention, there is provided a method for controlling a temperature of an injection molding machine using a temperature controller, the method comprising the steps of:

controlling a temperature of feed water fed from a cooling tower to the injection molding machine by actuating a temperature controller for heating the water; and then

controlling a temperature of the injection molding machine by opening or closing a plurality of opening and closing means to regulate feeding of the water from the cooling tower to the injection molding machine.

The step of controlling the temperature of the injection molding machine is preferably performed by selectively opening or closing a plurality of the opening and closing means to regulate the inflow or discharge of the cooling water into or from the injection molding machine.

### BRIEF DESCRIPTION OF THE DRAWINGS

The above and other objects, features and other advantages of the present invention will be more apparent from the following detailed description taken in conjunction with the accompanying drawings, in which:

FIG. 1 is a schematic view of one preferred embodiment of a device for controlling a temperature of an injection molding machine using a temperature controller in accordance with the present invention;

FIG. 2 is a schematic view of another preferred embodiment of the device for controlling a temperature of an injection molding machine using a temperature controller in accordance with the present invention; and

FIG. 3 is a flow chart of temperature control actions of the device for controlling a temperature of an injection molding machine using a temperature controller in accordance with the present invention.

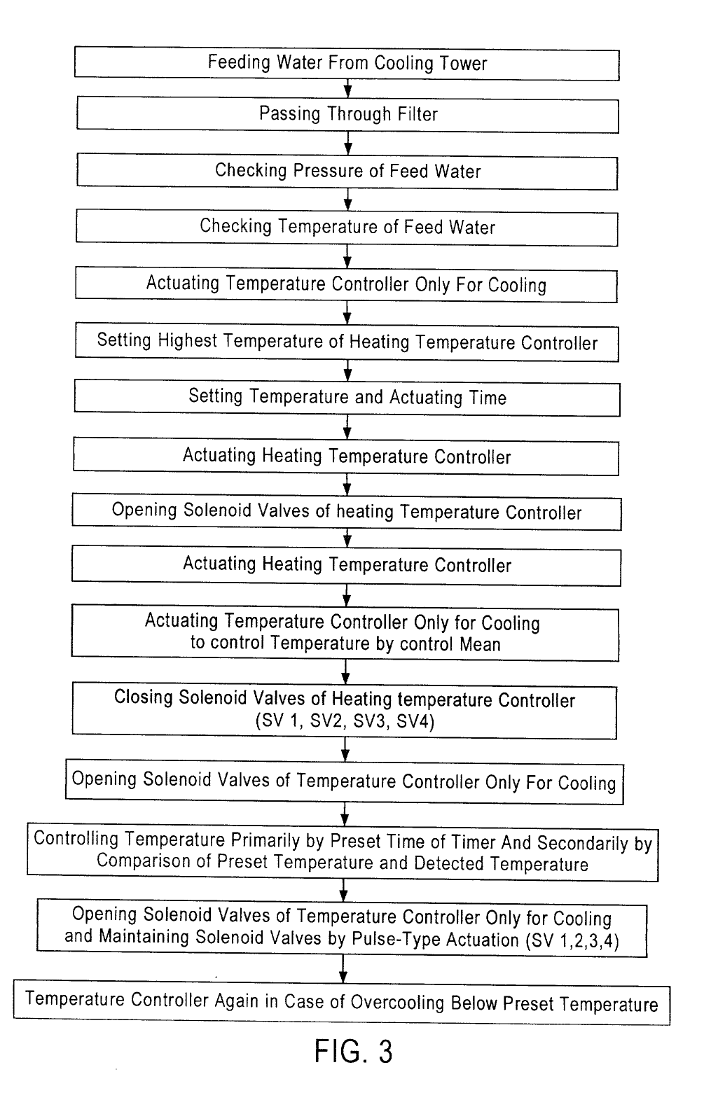

### DETAILED DESCRIPTION OF THE PREFERRED EMBODIMENTS

Hereinafter, a preferred embodiment of the present invention will be described with reference to the accompanying drawings. In the following description and all drawings, the same reference numerals are used to designate the same or similar components, and so repetition of the description of the same or similar components will be omitted.

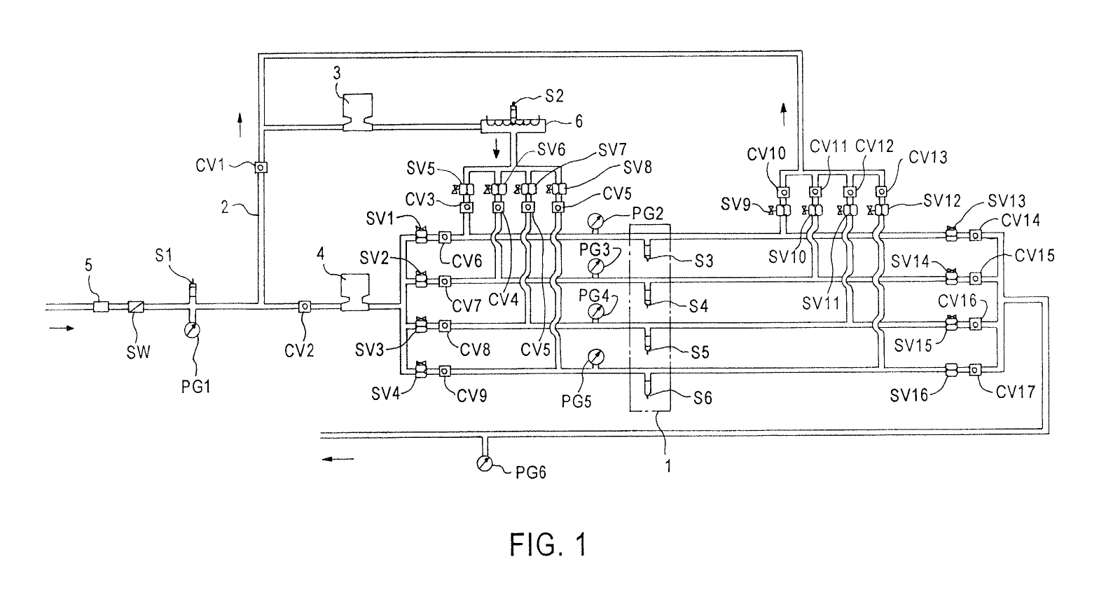

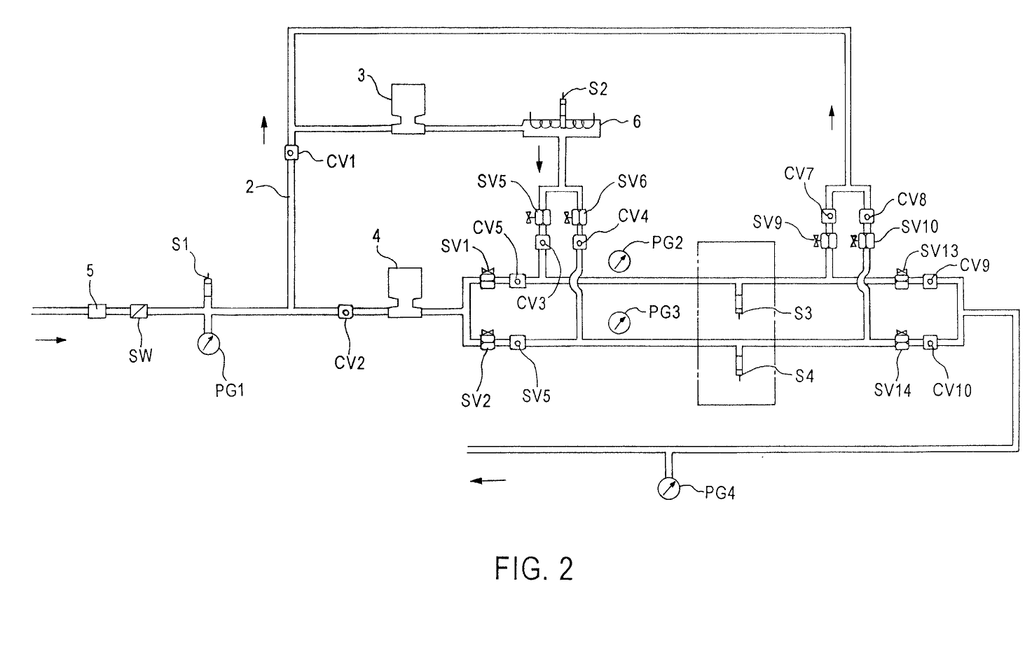

As shown in FIG. 1 and FIG. 2, the present invention concerns a device for controlling a temperature of an injection molding machine using a temperature controller by supplying cooling or hot water to a pipe within the injection molding machine comprising a fixed mold and a moving mold. FIG. 1 depicts the pipe diverging into two branch pipes and FIG. 2 depicts the pipe diverging into four branch pipes. Of course, solenoid valves or check valves are disposed corresponding to the number of the branch pipes.

Referring to FIG. 2, the temperature control device according to the present invention includes a first and a second pump 3, 4 for supplying feed water from a cooling tower to a pipe 2 within the injection molding machine 1 and a heater 6 by their pumping actions, respectively. The heater 6 heats the feed water supplied from the cooling tower by the pumping action of the first pump 3 and supplying the heated water to the pipe 2 within the injection molding machine 1. The temperature control device of the present invention also includes a first opening and closing means provided between the pipe 2 within the injection molding machine 1 and the heater 6 for regulating feeding of the water from the heater 6 to the pipe 2 within the injection molding 1, a second opening and closing means provided between the pipe 2 within the injection molding machine 1 and the first pump 3 for regulating returning of the water from the pipe 2 within the injection molding machine 1 to the first pump 3, a third opening and closing means provided between the pipe 2 within the injection molding machine 1 and the second pump 4 for regulating feeding of the water from the second pump 4 to the pipe 2 within the injection molding machine 1, a fourth opening and closing means provided between the pipe 2 within the injection molding machine 1 and the cooling tower for regulating discharging of the water from the pipe 2 within the injection molding machine 1 to the cooling tower. The temperature control device of the present invention further includes temperature sensors S1 to S6 for detecting temperatures of the feed water from the cooling tower, the hot water within the heater 6 and the cooling water within the injection molding machine 1, and control means for controlling operations of the injection molding machine 1 and controlling actions of the pumps 3, 4, the heater 6 and the first to fourth opening and closing means depending on temperature values of the temperature sensors and setting values of a timer.

Solenoids valves SV1 to SV16 are used as the first to the fourth opening and closing means. Check valves CV1 to CV17 may be provided at each of rear ends of the solenoid valves S1 to S16 so as to prevent inverse flowing of the cooling water, and the second and the fourth opening and closing means may be further provided with a manifold, respectively so as to reduce the number of the solenoid valves.

In addition, the control means is so constructed that it controls the temperatures of the injection molding machine 1 by selectively opening or closing a plurality of the opening and closing means, that is, the solenoid valves S1 to S16 to regulate the inflow or discharge of the cooling water into or from the injection molding machine 1.

Of non-explained reference numerals in the drawings, reference numerals “PG1 to PG6” designate pressure gauges for indicating pressures of the cooling water flowing through the pipe 2, and reference numeral “SW” designates a hydraulic switch actuated depending on water pressure of the feed water from the cooling tower.

The operation of so constructed temperature control device of the present invention is as follows:

First, the feed water from the cooling water (not shown) is filtered by passing through a filter 5 and is supplied to each of the first and the second pumps 3, 4. At this time, the hydraulic switch SW is actuated in accordance with the water pressure of the feed water from the cooling tower. In addition, the temperature sensor S1 and the pressure gauge PG1 detect the temperature and the pressure of the feed water from the cooling tower and send signals to the control means (not shown), respectively.

While electric power is being supplied to the temperature controller only for heating the water, the highest temperature of the temperature control heater and the heater actuating time of the timer are then set. Thus, the heater 6, used as the temperature controller for heating the water, is actuated under the control of the control means. The control means simultaneously closes the solenoid valves SV1 to SV4 to prevent the feed water from being supplied immediately to the injection molding machine 1.

The control means also opens the solenoid valves SV5 to SV8 and the solenoid valves SV9 to SV12 to allow the outflow of water heated by the heater 6 through the pipe 2 and to preheat the injection molding machine 1. At this time, the control means compares the temperature value detected by the temperature sensor S2 with the preset temperature value to control quantity of the heat generated by the heater 6.

After the preheating of the injection molding machine 1 is finished in this way, the control means closes the solenoid valves SV5 to SV8 and the solenoid valves SV9 to SV12 and opens the solenoid valves SV1 to SV4 and the solenoid valves SV13 to SV16 in order that the feed water from the temperature controller only for cooling the water, used as the cooling tower, may be supplied immediately to the injection molding machine 1 to lower its temperature.

When the solenoid valves SV1 to SV4 and the solenoid valves SV13 to SV16 are made to be in opened states, the control means compares the temperature values detected by the temperature sensors S3 to S6 with the preset temperature value to control the temperature of the injection molding machine 1 by regulating the opened state of the solenoid valves SV1 to SV4 and the solenoid valves SV13 to SV16.

In particular, the control means not only controls the opening and closing actions of the solenoid valves SV1 to SV4 by means of a pulse-type action, but also controls the temperature of the injection molding machine 1 by separately opening or closing the solenoid valves provided in the pipe diverging into a plurality of branch pipes within the injection molding machine, thereby making it possible to uniformly control the temperature of the injection molding machine as a whole and thus to lower a defective rate of the products.

Preferably, by making diameters of the branch pipes for drainage larger and providing a separate pump for drainage so as to shorten an exchange time of the cooling water, the whole temperature of the injection molding machine can be rapidly and uniformly controlled.

As described above, the present invention provides a device and a method for controlling a temperature of an injection molding machine using a temperature controller, in which a temperature of feed water fed from a cooling tower to the injection molding machine is controlled by heating of a heater, and then a temperature of the injection molding machine is controlled by opening or closing a plurality of opening and closing means to regulate feeding of the water from the cooling tower to the injection molding machine, thereby shortening a time required for controlling the temperature of the injection molding machine and a preheating time at an initial stage of operation.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A device for controlling a temperature of an injection molding machine using a temperature controller comprising:
a first and a second pump for forcedly supplying feed water from a cooling tower to a pipe within the injection molding machine and a heater by their pumping actions, respectively, the heater heating the feed water supplied from the cooling tower by the pumping action of the first pump and supplying the heated water to the pipe within the injection molding machine;
a first opening and closing means provided between the pipe within the injection molding machine and the heater for regulating feeding of the water from the heater to the pipe within the injection molding;
a second opening and closing means provided between the pipe within the injection molding machine and the first pump for regulating returning of the water from the pipe within the injection molding machine to the first pump;
a third opening and closing means provided between the pipe within the injection molding machine and the second pump for regulating feeding of the water from the second pump to the pipe within the injection molding machine;
a fourth opening and closing means provided between the pipe within the injection molding machine and the cooling tower for regulating discharging of the water from the pipe within the injection molding machine to the cooling tower;
temperature sensors for detecting temperatures of the feed water from the cooling tower, the hot water within the heater and the cooling water within the injection molding machine; and
control means for controlling operations of the injection molding machine and controlling actions of the pumps, the heater and the first to fourth opening and closing means depending on temperature values of the temperature sensors and setting values of a timer.

2. A device according to claim 1, wherein each of the first to the fourth opening and closing means is a solenoid valve.

3. A device according to claim 1 or 2, wherein a check valve is provided at a rear end of the solenoid valve.

4. A device according to claim 1, wherein the second and the fourth opening and closing means further includes a manifold, respectively.

5. A device according to claim 1, wherein the control means controls the temperatures of the injection molding machine by selectively opening or closing a plurality of the opening and closing means to regulate the inflow or discharge of the cooling water into or from the injection molding machine.

6. A method for controlling a temperature of an injection molding machine using a temperature controller, the method comprising the steps of:
controlling a temperature of feed water fed from a cooling tower to the injection molding machine by actuating a temperature controller for heating the water; and then
controlling a temperature of the injection molding machine by opening or closing a plurality of opening and closing means to regulate feeding of the water from the cooling tower to the injection molding machine.

7. A method according to claim 6, wherein the step of controlling the temperature of the injection molding machine is performed by selectively opening or closing a plurality of the opening and closing means to regulate the inflow or discharge of the cooling water into or from the injection molding machine.
